(19) United States
(12) Patent Application Publication
(10) Pub. No.: US 2011/0177263 A1
(43) Pub. Date: Jul. 21, 2011

(54) RECORDING MEDIUM AND IMAGE FORMING APPARATUS

(75) Inventors: Shinji HASEGAWA, Kanagawa (JP); Minquan TIAN, Kanagawa (JP); Yuka ITO, Kanagawa (JP); Suguru NAKASO, Kanagawa (JP); Makoto FURUKI, Kanagawa (JP)

(73) Assignee: FUJI XEROX CO., LTD., Tokyo (JP)

(21) Appl. No.: 12/874,539

(22) Filed: Sep. 2, 2010

(30) Foreign Application Priority Data
Jan. 18, 2010 (JP) 2010-008371

(51) Int. Cl. B44F 1/10; G03G 15/08

(52) U.S. Cl. 428/29; 399/53

(57) ABSTRACT

A recording medium includes a first image that is read with infrared light and that is formed of plural dots having infrared absorptivity, part of the plural dots being invisible first dots, the remaining dots being visible second dots; and a visible second image that is formed of the second dots or the second dots and visible third dots not having infrared absorptivity.

### CROSS-REFERENCE TO RELATED APPLICATIONS

This application is based on and claims priority under 35 USC 119 from Japanese Patent Application No. 2010-008371 filed Jan. 18, 2010.

### BACKGROUND

The present invention relates to a recording medium and an image forming apparatus.

### SUMMARY

According to an aspect of the invention, there is provided a recording medium including a first image that is read with infrared light and that is formed of plural dots having infrared absorptivity, part of the plural dots being invisible first dots, the remaining dots being visible second dots; and a visible second image that is formed of the second dots or the second dots and visible third dots not having infrared absorptivity.

### BRIEF DESCRIPTION OF THE DRAWINGS

Exemplary embodiments of the present invention will be described in detail based on the following figures, wherein:

FIG. 1 is a schematic drawing showing an example of a recording medium according to an exemplary embodiment of the present invention;

FIG. 2A is a schematic drawing showing an example of an infrared image and a related image formed in a specified area on a recording medium according to an exemplary embodiment of the present invention;

FIG. 2B is an enlarged schematic drawing showing a portion of FIG. 2A;

FIG. 2C is a schematic drawing showing an infrared image formed by reading the image shown in FIG. 2B with infrared light;

FIG. 3 is an enlarged schematic drawing showing a portion of FIG. 2A in a different mode from FIG. 2B;

FIG. 4 is a schematic drawing showing an example of an image forming apparatus according to an exemplary embodiment of the present invention;

FIG. 5 is a functional block diagram showing an example of an image processing device in an image forming apparatus according to an exemplary embodiment of the present invention;

FIGS. 6A and 6B are schematic drawings each showing an infrared image and a related image according to an exemplary embodiment of the present invention in a different mode from FIG. 28;

FIG. 7 is a diagram showing a visible and near-infrared absorption spectrum of a perimidine-based squarylium dye represented by structural formula (I) in a tetrahydrofuran solution obtained in Test Example 1;

FIG. 8 is a diagram showing X-ray diffraction spectra of particles (A) and a raw material in test examples;

FIG. 9 is a diagram showing X-ray diffraction spectra of particles (A) and particles (B) in test examples;

FIG. 10 is a diagram showing visible near-infrared absorption spectra of latex patches prepared using particles (A), particles (B), VONPc, particles (C), and particles (D) in test examples; and

FIG. 11 is a diagram showing light resistance, i.e., a relation between the irradiation time and reflectance, of latex patches prepared using particles (A), particles (B), VONPc, particles (C), and particles (D) in test examples.

### DETAILED DESCRIPTION

Exemplary embodiments of the present invention will be described with reference to the drawings.

### (Recording Medium)

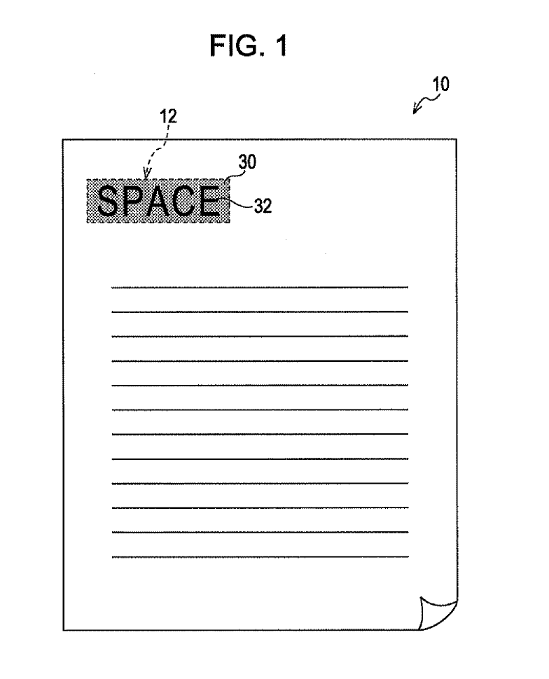

As shown in FIG. 1, in a recording medium 10 according to an exemplary embodiment of the present invention, a first image 14 (hereinafter referred to as an “infrared image”) that is read by irradiation with infrared light, and a visible second image 16 (hereinafter referred to as a “visible image”) are formed in a specified area 12.

The recording medium 10 according to the exemplary embodiment corresponds to a recording medium according to an exemplary embodiment of the present invention, the first image corresponds to an infrared image 30, and the second image corresponds to a related image 32.

The infrared image 30 is read by receiving reflected light of the irradiated infrared light. The infrared image 30 may be a binarized image code pattern formed by coding predetermined information, a character, a number, a symbol (triangular or asterisk mark), or the like as long as it may be read with infrared light.

The related image 32 is a visible image that indicates related information about the infrared image 30.

The related information may be information about the infrared image 30, and specifically includes information indicating the presence of the infrared image 30 on the recording medium 10, the position of the infrared image 30 on the recording medium 10, the form type of the infrared image 30, the type and outlines of the information of the infrared image 30, the type of a recording material constituting the infrared image 30, and the like.

The related image 32 is a visible image. The related image 32 may be an image indicating related information about the infrared image 30. The related image 32 may be a number or symbol (triangular or asterisk mark) indicating the related information, a character string indicating the position of the related information and an operation to be performed by an user for the related information, or a predetermined number or symbol representing the contents of the related information.

In the exemplary embodiment, the infrared image 30 and the related image 32 are formed in the same specified area 12. The position of the specified area 12 is not limited and may be an end or a center of the recording medium 10 as long as the specified area 12 is an area on the recording medium 10.

The infrared image 30 formed in the specified area 12 are formed of plural dots having infrared absorptivity, part of the plural dots being visible dots that constitute the related image 32.

Therefore, even when the infrared image 30 and the related image 32 are formed in the same area, a decrease in reading precision of the infrared image 30 due to the related image 32 is considered to be suppressed.

The infrared image 30 and the related image 32 are described in detail below.

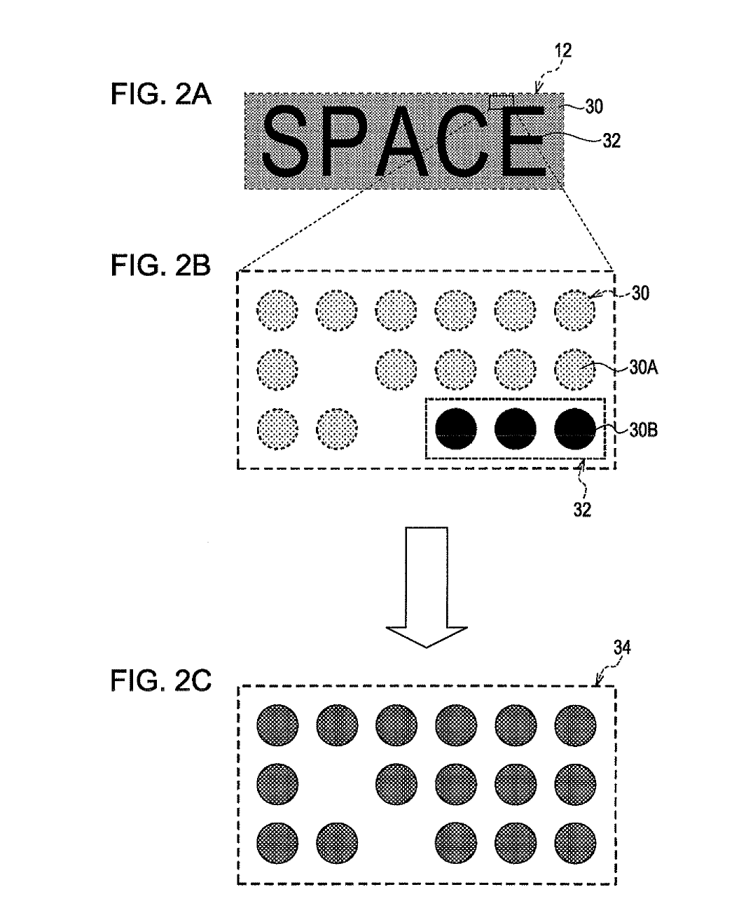

The infrared image 30 is an image to be read by infrared irradiation, that is, an image to be read by receiving reflected light of the irradiated infrared light. In detail, the infrared image 30 are formed of plural dots having infrared absorptivity. As shown in FIGS. 2A and 2B, part of the plural dots having infrared absorptivity are invisible dots 30A, and the remaining dots are visible dots 30B.

In the exemplary embodiment, the term “invisible” represents that visual recognition with visible light is difficult and, ideally, recognition with visible light is impossible (i.e., invisible). Specifically, “invisible” represents that a color difference ΔE between the recording medium 10 and the invisible dots 30A formed on the recording medium 10 is about 16 or less.

In the exemplary embodiment, the term “visible” represents that visual recognition with visible light is possible. Specifically, “visible” represents that a color difference ΔE between the recording medium 10 and the related image 32 formed as a visible image is about 16 or more.

In the exemplary embodiment, the expression “having infrared absorptivity” represents that when an image with a print coverage of 100% that is formed of dots having infrared absorptivity is irradiated with infrared light, reflectance of the infrared light is about 35% or less at least one of the wavelengths within the wavelength region of the infrared light.

The infrared image 30 is read by using, as an optical reading light source, a semiconductor laser or a light-emitting diode that irradiates light at a wavelength within the infrared region and using a general-purpose light-receiving element having high spectral sensitivity to infrared light. As the light-receiving element, for example, a silicon light-receiving element (CCD or the like) may be used. For example, the infrared image 30 is read as an infrared image 34 by reading reflected light of the irradiated light in the infrared wavelength region, the infrared image 34 including the invisible dots 30A and the visible dots 30B as shown in FIG. 2C.

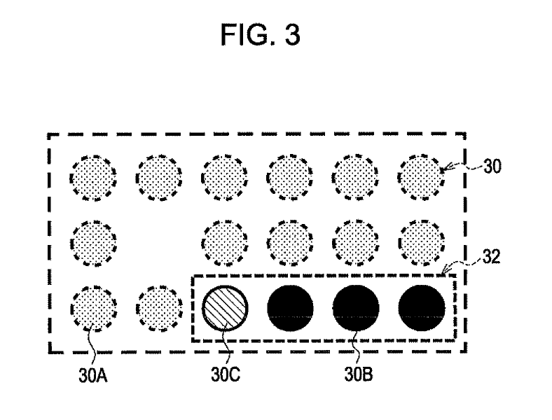

On the other hand, the related image 32 may be a visible image, and specifically includes the visible dots 30B among the plural dots that form the infrared image 30 (refer to FIGS. 2A and 2B) or the visible dots 30B among the plural dots that form the infrared image 30 and visible dots 30C (refer to FIG. 3) that do not form the infrared image 30 (i.e., do not have infrared absorptivity).

The visible dots (the visible dots 30B or the visible dots 30B and 30C) that constitute the related image 32 may be dots that are recognized by reflection of visible light. That is, the dots that constitute the related image 32 may be dots having infrared absorptivity or dots not having infrared absorptivity as long as the dots are visible dots. However, among the plural dots that constitute the related image 32, the dots overlapping the dots that constitute the infrared image 30 or the dots formed in place of the dots that constitute the infrared image 30 are dots having infrared absorptivity (the visible dots 30B having infrared absorptivity).

Among the plural dots that constitute the related image 32, the dots other than the dots that constitute the infrared image 30 may be visible dots not having infrared absorptivity (the visible dots 30C). Among the plural dots that constitute the related image 32, the dots other than part of the plural dots that constitute the infrared image 30 are visible dots not exhibiting infrared absorptivity. Therefore, the related image 32 is formed by also using the dots not having infrared absorptivity while suppressing false recognition of the infrared image 30 within an infrared reading area.

Among the plural dots that constitute the infrared image 30, the visible dots 30B may be substituted by the invisible dots 30A or may be formed to overlap the invisible dots 30A.

As described above, the infrared image 30 includes the plural dots having infrared absorptivity, part of the dots being the invisible dots 30A, and the remainder being the visible dots 30B. The related image 32 includes the visible dots 30B among the plural dots that constitute the infrared image 30 or the visible dots 30B and the visible dots 30C. Therefore, even when the infrared image 30 and the related image 32 are formed in the same area, a decrease in reading precision of the infrared image 30 due to the related image 32 is considered to be suppressed.

In particular, even when among the plural dots that constitute the related image 32, the dots within an area overlapping the infrared image 30 are made of a material such as carbon black, that absorbs infrared light, a decrease in reading precision of the infrared image 30 is considered to be suppressed because the dots having infrared absorptivity among the plural dots that constitute the related image 32 function as part of the dots that constitute the infrared image 30.

The dots (the invisible dots 30A and the visible dots 30B) that constitute the infrared image 30 have the same size as that of the dots (the visible dots 30B) that constitute at least a portion of the infrared image 30 among the dots that constitute the related image 32. In the case of the same size dots, when the infrared image 30 is read with infrared light, the invisible dots 30A and the visible dots 30B are read without being discriminated (without being discriminated in size). Therefore, a decrease in reading precision of the infrared image 30 is considered to be further suppressed.

The term “the same size dots” does not represent that the dot sizes are completely the same. For example, dots formed to have the same size by an image forming apparatus are regarded as “the same size dots” even when error slightly occurs. For example, in the case of micron size dots, if the average diameter of dots used as one of targets for comparison falls within a range of 0.8 times or more and 1.2 times or less the average diameter of dots as the other target, the dots are regarded as “the same size dots”.

Next, recording materials used for recording the invisible dots 30A having infrared absorptivity, the visible dots 30B having infrared absorptivity, and the visible dots 30A not having infrared absorptivity are described.

The invisible dots 30A having infrared absorptivity are recorded with a recording material that has infrared absorptivity and transparency (a light reflectance of about 60% or more within a wavelength region of 450 nm or more and 650 nm or less in a central portion of the visible region). An example of the recording material used for recording the invisible dots 30A is a transparent recording material containing a colorant having infrared absorptivity.

The colorant having infrared absorptivity may be any material as long as it has infrared absorptivity and does not impair the transparency of the recording material, but is desirably a material containing a perimidine-based squarylium dye represented by structural formula (I) below.

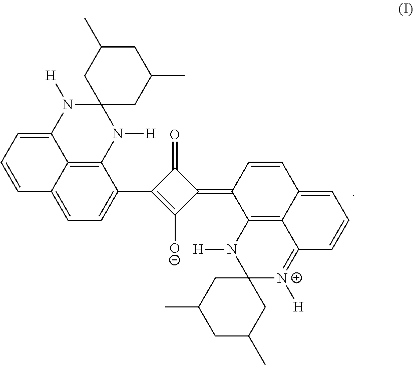

The perimidine-based squarylium dye represented by the structural formula (I) has high light resistance as compared with other dyes used for invisible images, such as naphthalocyanine-based dye. The reason for this is that the perimidine-based squarylium dye represented by the structural formula (I) has high crystallinity and low solubility in a binder resin as compared with other dyes usually used for invisible images. Therefore, intramolecular bond breaking due to absorption of optical energy of irradiated light is considered to be suppressed.

As described above, the perimidine-based squarylium dye represented by the structural formula (I) has high crystallinity as compared with dyes usually used for invisible images. Examples of such a dye include dyes showing, in a powder X-ray diffraction spectrum measured by X-ray irradiation at a wavelength of 1.5405 Å using a Cu target, diffraction peaks at Bragg angles (2θ±0.2°) of at least 9.9°, 13.2°, 19.9°, 20.8°, and 23.0°; diffraction peaks at Bragg angles of at least 17.7°, 19.9°, 22.1°, 23.2°, and 24.9°; diffraction peaks at Bragg angles of at least 8.9°, 17.1°, 18.4°, 22.6°, and 24.2°; and the like.

Among these, a dye showing diffraction peaks at 17.7°, 19.9°, 22.1°, 23.2°, and 24.9° is good in view of light resistance.

The perimidine-based squarylium dye represented by the structural formula (I) has sufficiently low light absorbing ability in a visible light wavelength region of 400 nm or more and 750 nm or less and has sufficiently high absorbing ability in a near-infrared light wavelength region of 750 nm or more and 1000 nm or less.

The term “sufficiently low light absorbing ability” represents that the molar absorption coefficient of a solution within a visible light wavelength region of 400 nm to 450 nm is at least 8100 M⁻¹ cm⁻¹ or less, the molar absorption coefficient of a solution within a visible light wavelength region of 450 nm to 650 nm is at least 3400 M⁻¹ cm⁻¹or less, the molar absorbance coefficient of a solution within a visible light wavelength region of 650 nm to 690 nm is at least 8800 M⁻¹ cm⁻¹ or less, and the molar absorbance coefficient of a solution within a visible light wavelength region of 690 nm to 750 nm is at least 3700 M⁻¹ cm⁻¹ or less.

The term “sufficiently high light absorbing ability” represents that the maximum molar absorption coefficient of a solution over the entire near-infrared light wavelength region of 750 nm or more and 1000 nm or less is at least 1.5×10⁵ M⁻¹ cm⁻¹ or more.

Therefore, the invisible dots 30A formed with a transparent recording material containing the perimidine-based squarylium dye represented by the structural formula (I) satisfies both invisibility with visible light and easy readability with near-infrared light. In addition, the visible dots 30B are excellent in easy readability with near-infrared light.

The recording material used for forming the invisible dots 30A having infrared absorptivity according to the exemplary embodiment satisfies conditions represented by the following expressions (II) and (III):

0≦ΔE≦16 Expression (II)

(100−R)≧75 Expression (III)

In the expression (II), ΔE represents a color difference in a CIE 1976 L*a*b* color system and is represented by expression (IV) below. In the expression (III), R (unit: %) represents infrared reflectance of the invisible dots 30A at a wavelength of 850 nm.

ΔE=\sqrt{(L₁−L₂)²+(a₁−a₂)²+(b₁−b₂)²} (IV)

By satisfying the conditions represented by the expressions (II) and (III), invisibility and near-infrared easy readability of the invisible dots 30A are considered to be satisfied regardless of the color of the recording material. In addition, the recording material 10 on which the infrared image 30 including the invisible dots 30A is recorded is expected to have long-term reliability due to high light resistance.

In the expression (IV), L₁, a₁, and b₁ represent a L value, a value, and b value, respectively, of a surface of the recording medium 10 on which an image is not formed, and L₂, a₂, and b₂ represent L value, a value, and b value, respectively, of an invisible image (formed with the invisible dots 30A) formed on the recording medium 10 with a deposit of 4 g/m² using the above-described recording material.

In the expression (IV), L₁, a₁, b₁, L₂, a₂, and b₂ are determined using a reflection spectrodensitometer. In the exemplary embodiment, L₁, a₁, b₁, L₂, a₂, and b₂ are measured using X-Rite 939 manufactured by X-Rite Inc. as a reflection spectrodensitometer.

The perimidine-based squarylium dye represented by the structural formula (I) is obtained by, for example, according to the following reaction scheme:

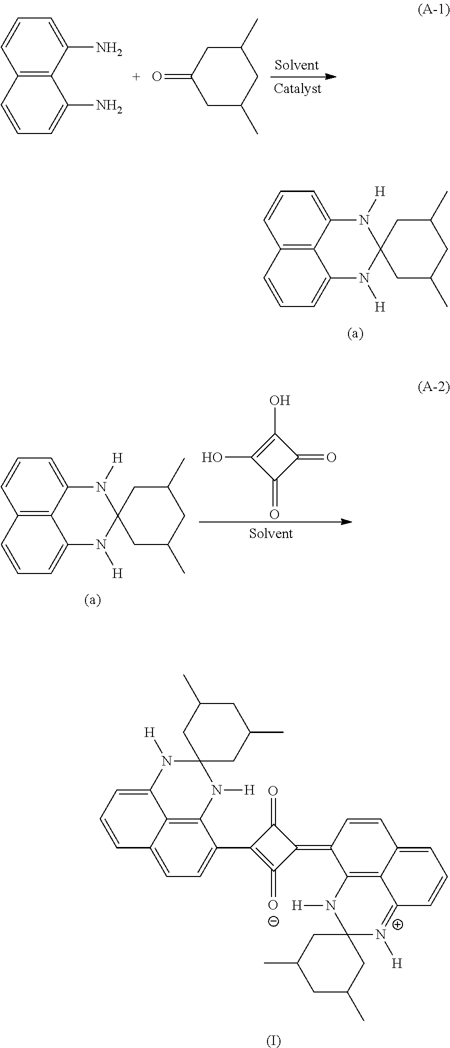

More specifically, 1,8-diamino naphthalene is reacted with 3,5-dimethylcyclohexanone in the presence of a catalyst in a solvent under the condition of azeotropic reflux to produce a perimidine intermediate (a) (step (A-1)).

Examples of the catalyst used in the step (A-1) include p-toluenesulfonic acid monohydrate, benzenesulfonic acid monohydrate, 4-chlorobenzenesulfonic acid hydrate, pyridine-3-sulfonic acid, ethanesulfonic acid, sulfuric acid, nitric acid, acetic acid, and the like. Examples of the solvent used in the step (A-1) include alcohols, aromatic hydrocarbons, and the like. The perimidine intermediate (a) is purified by high-performance column chromatography or recrystallization.

Next, the perimidine intermediate (a) is reacted with 3,4-dihydroxycyclobut-3-ene-1,2-dione (referred to as “squaric acid” or “quadratic acid”) in a solvent under the condition of azeotropic reflux to produce the perimidine-based squarylium dye represented by the structural formula (I) (step (A-2)). The step (A-2) is performed in a nitrogen gas atmosphere.

Examples of the solvent used in the step (A-2) include alcohols such as 1-propanol, 1-butanol, 1-pentanol, and the like; aromatic hydrocarbons such as benzene, toluene, xylene, monochlorobenzene, and the like; ethers such as tetrahydrofuran, dioxane, and the like; halogenated hydrocarbons such as chloroform, dichloroethane, trichloroethane, dichloropropane, and the like; and amides such as N,N-dimethylformamide, N,N-dimethylacetamide, and the like. The alcohols may be used alone, but solvents such as the aromatic hydrocarbons, the ethers, the halogenated hydrocarbons, or the amides may be used as a mixture with an alcohol solvent. Specific examples of the solvent include 1-propanol, 2-propanol, 1-butanol, 2-butanol, a mixed solvent of 1-propanol and benzene, a mixed solvent of 1-propanol and toluene, a mixed solvent of 1-propanol and N,N-dimethylformamide, a mixed solvent of 2-propanol and benzene, a mixed solvent of 2-propanol and toluene, a mixed solvent of 2-propanol and N,N-dimethylformamide, a mixed solvent of 1-butanol and benzene, a mixed solvent of 1-butanol and toluene, a mixed solvent of 1-butanol and N,N-dimethylformamide, a mixed solvent of 2-butanol and benzene, a mixed solvent of 2-butanol and toluene, and a mixed solvent of 2-butanol and N,N-dimethylformamide. When a mixed solvent is used, the concentration of the alcohol solvent is about 1% by volume or more or about 5% by volume or more and about 75% by volume or less.

In the step (A-2), the molar ratio of the perimidine derivative (a) to 3,4-dihydroxycyclobut-3-ene-1,2-dione (number of moles of the perimidine derivative (a)/number of moles of 3,4-dihydroxycyclobut-3-ene-1,2-dione) is about 1 or more and 4 or less or 1.5 or more and 3 or less. When the molar ratio is less than about 1, the yield of the perimidine-based squarylium dye represented by the structural formula (I) may be decreased, while when the molar ratio exceeds about 4, the utilization efficiency of the perimidine derivative (a) may be decreased, thereby making it difficult to isolate and purify the perimidine-based squarylium dye represented by the structural formula (I).

Further, in the step (A-2), the use of a dehydrating agent tends to shorten the reaction time and improve the yield of the perimidine-based squarylium dye represented by the structural formula (I). The dehydrating agent is not particularly limited as long as it does not react with the perimidine intermediate (a) and 3,4-dihydroxycyclobut-3-ene-1,2-dione. Examples of the dehydrating agent include orthoformates such as trimethyl orthoformate, triethyl orthoformate, tripropyl orthoformate, tributyl orthoformate, and the like; molecular sieve; and the like.

The reaction temperature in the step (A-2) depends on the type of the solvent used but the temperature of the reaction solution is 60° C. or more or 75° C. or more. For example, when a mixed solvent of 1-butanol and toluene is used, the temperature of the reaction solution is 75° C. to 105° C.

The reaction time in the step (A-2) depends on the type of the solvent used or the temperature of the reaction solution. For example, when the reaction is effected using a mixed solvent of 1-butanol and toluene at a reaction solution temperature of 90° C. or more and 105° C. or less, the reaction time is 2 hours or more and 4 hours or less.

The perimidine-based squarylium dye represented by the structural formula (I) and produced in the step (A-2) is purified by washing with solvent and high-performance column chromatography or recrystallization.

In the recording medium 10 according to the exemplary embodiment of the present invention, the perimidine-based squarylium dye represented by the structural formula (I) and contained in the recording material used for recording the invisible dots 30A is subjected to a pigment-forming treatment. The pigment-forming treatment is considered to easily change a crystal system.

Therefore, the method and conditions for the pigment-forming treatment are adjusted so as to suppress conversion of the crystal system of perimidine-based squarylium dye particles (raw material) before the pigment-forming treatment. That is, the method and conditions are adjusted to show X-ray diffraction peaks of the perimidine-based squarylium dye particles. Specifically, in a powder X-ray diffraction spectrum measured by X-ray irradiation at a wavelength of 1.5405 Å using a Cu target, the perimidine-based squarylium dye shows diffraction peaks at Bragg angles (2θ±0.2°) of at least 17.7°, 19.9°, 22.1°, 23.2°, and 24.9°. Therefore, from the viewpoint of improvement in light resistance, the method and conditions are adjusted so that the perimidine-based squarylium dye after the pigment-forming treatment shows these diffraction peaks.

As a method for the pigment-forming treatment, for example, the perimidine-based squarylium dye represented by the structural formula (I) is mixed with an aqueous solution of sodium dodecylbenzenesulfonate, and the resultant mixture is subjected to the pigment-forming treatment. If required, the concentration of the mixture may be adjusted by adding water. As an apparatus used for the pigment-forming treatment, a breads mill may be used.

In the exemplary embodiment, the recording material that constitutes the invisible dots 30A contains particles of the perimidine-based squarylium dye represented by the structural formula (I). The perimidine-based squarylium dye represented by the structural formula (I) has high intermolecular interaction and high crystallinity of particles as compared with dyes usually used for invisible images. Therefore, when the recording material contains particles of the perimidine-based squarylium dye represented by the structural formula (I), infrared coloring ability and light resistance are considered to be further enhanced as compared with dyes usually used for invisible images.

The particles of the perimidine-based squarylium dye represented by the structural formula (I) are prepared by, for example, dissolving the purified product after the step (A-2) in tetrahydrofuran, injecting the resultant solution into ice-cold distilled water using a syringe or the like under stirring to produce precipitates, filtering out the precipitates, washing the precipitates with distilled water, and then drying the precipitates. In this case, the particle diameter of the resulting precipitates is adjusted by adjusting the concentration of the perimidine-based squarylium dye represented by the structural formula (I) in the solution, the injection rate of the solution, the amount or temperature of distilled water, the stirring speed, or the like.

The median diameter d50 of the particles of the perimidine-based squarylium dye represented by the structural formula (I) is, for example, 10 nm or more and 300 nm or less or 20 nm or more and 200 nm or less.

When the median diameter d50 of the particles of the perimidine-based squarylium dye represented by the structural formula (I) is within the above range, it is considered that a decrease in light resistance is suppressed, and the infrared coloring ability is improved.

The treatment for forming particles and controlling the median diameter may be performed either before or after the pigment-forming treatment.

In the exemplary embodiment, the recording material that constitutes the invisible dots 30A may further contain a component other than the perimidine-based squarylium dye represented by the structural formula (I) as long as the recording material and the invisible dots 30A formed with the recording material are invisible. The content of the perimidine-based squarylium dye represented by the structural formula (I) in the recording material is about 0.05% by mass or more and about 3% by mass or less or about 0.1% by mass or more and about 2% by mass or less based on the whole mass (100% by mass) of the recording material.

As described above, the perimidine-based squarylium dye represented by the structural formula (I) has good light resistance, and thus the recording material containing the dye is excellent in light resistance. In view of further improving the light resistance of the recording material, a stabilizer may be further added. The stabilizer receives energy form an organic near-infrared absorbing dye in an excited state, and thus a stabilizer having an absorption band on the longer wavelength side than the absorption band of a near-infrared absorbing dye is used. In addition, it is desirable to use a stabilizer that is not easily decomposed by singlet oxygen and that has high compatibility with the perimidine-based squarylium dye represented by the structural formula (I). Examples of the stabilizer having these characteristics include organometallic complex compounds. In particular, compounds represented by the following general formula (V) are used.

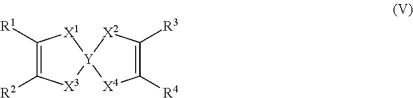

In the general formula (V), R¹, R², R³, and R⁴ may be the same or different and each represent a substituted or unsubstituted phenyl group. When phenyl groups represented by R¹, R², R³, and R⁴ have substituents, the substituents include H, NH₂, OH, N(CₕH₂ₕ₊₁)₂, OCₕH₂ₕ₊₁, CₕH₂ₕ₊₁, CₕH₂ₕ₋₁, CₕH₂ₕOH, CₕH₂ₕOCᵢH₂ᵢ₊₁ (h represents an integer of 1 to 18, and i represents an integer of 1 to 6), and the like. X¹, X², X², and X⁴ may be the same or different and each represent O, S, or Se, and Y represents a transition metal such as Ni, Co, Mn, Pd, Cu, Pt, or the like.

Among the compounds represented by the general formula (V), compounds represented by the following structural formula (VI) are desired.

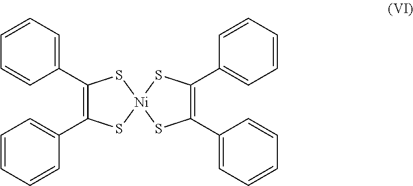

The concentration of the stabilizer contained in the recording material is about 1/10 or more and 2 times or less the mass of the perimidine-based squarylium dye represented by the structural formula (I).

On the other hand, the recording material for recording the visible dots 30B having infrared absorptivity contains, as a colorant, a colorant having both characteristics of infrared absorptivity and visible light reflectivity or both a colorant having infrared absorptivity and a colorant having visible light reflectivity.

As the colorant having infrared absorptivity, a usual colorant having infrared absorptivity may be used, but it is desired to use the perimidine-based squarylium dye represented by the structural formula (I). Examples of the colorant having visible light reflectivity include usual colorants such as C (cyan), M (magenta), Y (yellow), and the like. Examples of the colorant having infrared absorptivity and visible light reflectivity include carbon black and the like.

As the recording material for recording the visible dots 30C not having infrared absorptivity, for example, a recording material containing, as a colorant, a material that does not have infrared absorptivity but has visible light reflectivity may be used. Examples of the colorant that does not have infrared absorptivity but has visible light reflectivity include usual colorants such as C (cyan), M (magenta), Y (yellow), and the like.

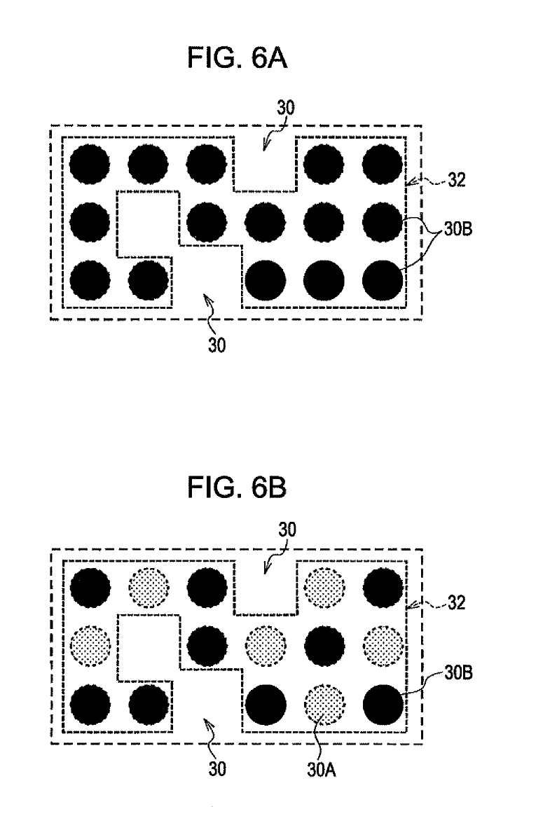

In the exemplary embodiment, description is made of the case in which the infrared image 30 is formed of the invisible dots 30A having infrared absorptivity and the visible dots 30B having infrared absorptivity. However, as long as the infrared image 30 is read by irradiation with infrared light, the infrared image 30 may be an image shown by an area other than a collection of the visible dots 30B having infrared absorptivity on the recording medium 10 (refer to an infrared image 30 shown in FIG. 6A). Specifically, as shown in FIG. 6A, the infrared image 30 may be an image shown by an area other than the related image 32 formed of the visible dots 30B having infrared absorptivity (an image shown by a collection of spaces between the visible dots 30B having infrared absorptivity in an area where no dot is formed on the recording medium 10).

For example, when the related image 32 is formed at a higher density than a predetermined density, all the dots constituting the related image 32 may be the visible dots 30B having infrared absorptivity, and the infrared image 30 may be formed of a collection of spaces between the visible dots 30B.

In this case, further, as shown in FIG. 6B, part of the visible dots 30B having infrared absorptivity may be the invisible dots 30A having infrared absorptivity. When part of the visible dots 30B having infrared absorptivity are the invisible dots 30A having infrared absorptivity, the visual color density of the related image 32 may be adjusted by adjusting the ratio of the invisible dots 30A in the related image 32.

### (Image Forming Apparatus)

An exemplary embodiment in which an electrophotographic image forming apparatus is used as an apparatus for forming the infrared image 30 and the related image 32 on the recording medium 10 is described below by way of example.

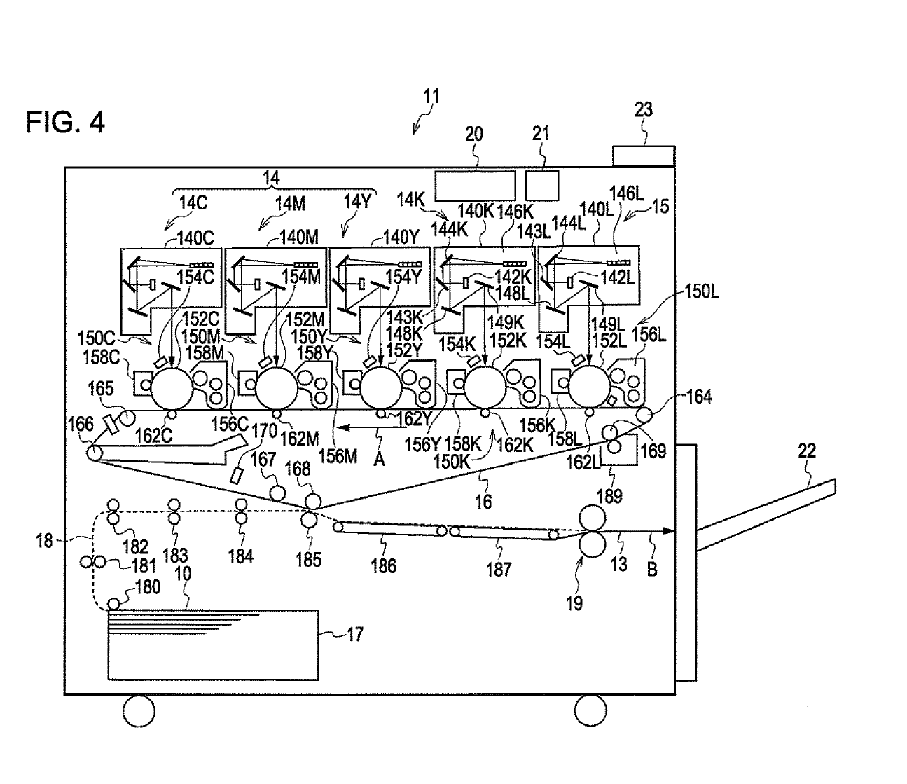

As shown in FIG. 4, an image forming apparatus 11 according to an exemplary embodiment of the present invention includes a invisible image recording unit 15, a visible image recording unit 14K, a visible image forming unit 14, an intermediate transfer member 16 that is rotated in an direction of arrow A shown in FIG. 4, a paper feed device 17, a paper transport path 18, a fixing device 19, an image processing device 20, an image formation control device 21, a paper discharge device 22, and an input/output device 23.

The image forming apparatus 11 corresponds to an image forming apparatus according to an exemplary embodiment of the present, the invisible image recording unit 15 corresponds to a first recording device of an image forming apparatus according to an exemplary embodiment of the present invention, the visible image recording unit 14K corresponds to a second recording device of an image forming apparatus according to an exemplary embodiment of the present invention, and the visible image recording unit 14 corresponds to a third recording device of an image forming apparatus according to an exemplary embodiment of the present invention.

In a description of outlines of the image forming apparatus 11, the image processing device 20 performs image processing such as synthesis, which will be described below, for image data that is input from the outside such as a personal computer through a network line or a radio line to output the processed image data to the image formation control device 21.

The image formation control device 21 controls the invisible image recording unit 15, the visible image recording unit 14K, and the visible image recording unit 14 on the basis of the processed image data (“first printing data, second printing data, and third printing data” described below). The image formation control device 21 may be included in the image processing device 20 so as to constitute part of the image processing device 20.

Further, the input/output device 23 such as a touch panel or the like is provided on the outer surface of the image forming apparatus 11. The input/output device 23 displays control information and direction information of the image forming apparatus 11 and receives direction information input by the user. That is, the user operates the image forming apparatus 11 through the input/output device 23. The input/output device 23 may be adapted to receive only input from a switch or the like or perform only output such as display or the like, or perform both the input and output.

The invisible image recording unit 15, the visible image recording unit 14K, and the visible image recording unit 14 are provided in the image forming apparatus 11. The invisible image recording unit 15 records the invisible dots 30A having infrared absorptivity. The visible image recording unit 14K records the visible dots 30B having infrared absorptivity. The visible image recording unit 14 records the visible dots 30C not having infrared absorptivity.

The visible image recording unit 14 includes plural visible image recording units corresponding to colors that constitute a color image not having infrared absorptivity. In the exemplary embodiment, the visible image recording unit 14 includes a visible image recording unit 14Y, a visible image recording unit 14M, and a visible image recording unit 14C corresponding to the colors of yellow (Y), magenta (M), and cyan (C), respectively.

The invisible image recording unit 15, the visible image recording unit 14K, and the visible image recording unit 14Y, the visible image recording unit 14M, and the visible image recording unit 14C that are included in the visible image recording unit 14 are arranged with spaces therebetween along the intermediate transfer member 16.

In the exemplary embodiment, the invisible image recording unit 15 is provided upstream of the visible image recording unit 14K and the visible image recording unit 14 in the transport direction of the intermediate transfer member 16. However, the invisible image recording unit 15 may be provided downstream of the visible image recording unit 14K and the visible image recording unit 14 or provided separately from the image forming apparatus 11.

In the exemplary embodiment, description is made on the assumption that the visible image recording unit 14K is a recording unit that records black dots as the visible dots 30B having infrared absorptivity. However, the visible image recording unit 14K is not limited to a recording unit that records black dots as long as it is a recording unit that records the visible dots 30B having infrared absorptivity. For example, the visible image recording unit 14K may include a device that records cyan visible dots 30B having infrared absorptivity. In this case, the visible image recording unit 14C included in the visible image recording unit 14 may be a device that records black visible dots 30C not having infrared absorptivity.

In detail, the invisible image recording unit 15 forms (primary transfer) the invisible dots 30A, that are formed of the recording material for recording the invisible dots 30A having infrared absorptivity, on the intermediate transfer member 16 on the basis of first printing data input from the image processing device 20 under control by the image formation control device 21. The invisible image recording unit 15 includes a light scanning device 140L that scans a laser beam according to the first printing data input from the image processing device 20 under control by the image formation control device 21, and an image forming device 150L that forms an electrostatic latent image by the laser beam scanned by the light scanning device 140L. The first printing data is adapted for recording the invisible dots 30A.

The light scanning device 140L modulates a semiconductor laser 142L according to the first printing data to emit laser beam LB from the semiconductor laser 142L according to the first printing data. The laser beam LB emitted from the semiconductor laser 142L is applied to a rotating polygon 146L through a first reflecting mirror 143L and a second reflecting mirror 144L, subjected to deflection scanning by the rotating polygon 146L, and applied to an image support 152L of the image forming device 150L through the second reflecting mirror 144L, a third reflecting mirror 148L, and a fourth reflecting mirror 149L.

The image forming device 150L includes the image support 152L that is rotated along a direction of arrow A, a primary charger 154L that charges the surface of the image support 152L, and a developing unit 156L that develops the electrostatic latent image formed on the image support 152L, and a remover 158L.

In the developing unit 156L, a toner formed of the recording material for recording the invisible dots 30A or the toner and a known carrier are supported. The toner is supplied from the developing unit 156L to the image support 152L. The image support 152L is uniformly charged by the charger 154L to form the electrostatic latent image by the laser beam applied by the light scanning device 140L. The electrostatic latent image formed on the image support 152L is developed with the invisible toner supplied from the developing unit 156L and then transferred to the intermediate transfer member 16. The toner, paper dust, and the like that adhere to the image support 152L after the transfer are removed by the remover 158L.

As a result, the invisible dots 30A are formed on the intermediate transfer member 16 by the invisible image recording unit 15.

The visible image recording unit 14K forms (primary transfer) the visible dots 30B, that are formed of the recording material for recording the visible dots 30B having infrared absorptivity, on the intermediate transfer member 16 on the basis of second printing data input from the image processing device 20 under control by the image formation control device 21.

The visible image recording unit 14K includes a light scanning device 140K that scans a laser beam according to the second printing data input from the image processing device 20 under control by the image formation control device 21, and an image forming device 150K that forms an electrostatic latent image by the laser beam scan by the light scanning device 140K. The second printing data is adapted for recording the visible dots 30B.

The light scanning device 140K modulates a semiconductor laser 142K according to the second printing data to emit laser beam LB(K) from the semiconductor laser 142K according to the second printing data. The laser beam LB(K) emitted from the semiconductor laser 142K is applied to a rotating polygon 146K through a first reflecting mirror 143K and a second reflecting mirror 144K, subjected to deflection scanning by the rotating polygon 146K, and applied to an image support 152K of the image forming device 150K through the second reflecting mirror 144K, a third reflecting mirror 148K, and a fourth reflecting mirror 149K.

The image forming device 150K includes the image support 152K that is rotated along a direction of arrow A, a charger 154K that charges the surface of the image support 152K, and a developing unit 156K that develops the electrostatic latent image formed on the image support 152K, and a remover 158K.

In the developing unit 156K, in the exemplary embodiment, as a toner formed of the recording material for recording the visible dots 30B having infrared absorptivity, a black toner having infrared absorptivity or the black toner and a known carrier are supported. The black toner is supplied to the image support 152K. The image support 152K is uniformly charged by the charger 154K to form the electrostatic latent image by the laser beam LB(K) applied by the light scanning device 140K. The electrostatic latent image formed on the image support 152K is developed with the black toner supplied from the developing unit 156K and then transferred to the intermediate transfer member 16. The toner, paper dust, and the like that adhere to the image support 152K after the transfer are removed by the remover 158K.

As a result, the visible dots 30B are formed on the intermediate transfer member 16 by the visible image recording unit 14K.

The visible image recording unit 14 forms (primary transfer) the visible dots 30C not having infrared absorptivity, that are formed of the recording material for recording the visible dots 30C not having infrared absorptivity, on the intermediate transfer member 16 on the basis of third printing data input from the image processing device 20 under control by the image formation control device 21. The visible image recording unit 14Y, the visible image recording unit 14M, and the visible image recording unit 14C included in the visible image recording unit 14 have the same configuration as that of the visible image recording unit 14K except that yellow, magenta, and cyan toners not having infrared absorptivity, respectively, are contained in place of the toner contained in the developing unit 156K and formed of the recording material for recording the visible dots 30B having infrared absorptivity. Therefore, these visible image recording units are not described in detail.

In the drawings, the component members of the visible image recording unit 14Y, the visible image recording unit 14M, and the visible image recording unit 14C are denoted by replacing, with “Y”, “M”, and “C”, respectively, “K” in the reference numerals of the corresponding component members of the visible image recording unit 14K. As a result, the visible dots 30C not having infrared absorptivity are formed by the visible image recording unit 14.

The order of the colors of the visible image recording unit 14Y, the visible image recording unit 14M, and the visible image recording unit 14C is not limited to the order of yellow (Y), magenta (M), and cyan (C), but may be any desired order.

The intermediate transfer member 16 is supported by support members 164, 165, 166, 167, 168, and 169 from the inner side and is rotated in a direction of arrow A by rotation of any one (for example, the support member 164) of the support members through a driving motor (not shown). As the intermediate transfer member 16, for example, an endless belt may be used, the endless belt being formed by shaping a synthetic resin film of flexible polyimide or the like into a strip, and connecting the both ends of the strip-shaped synthetic resin film by welding or the like.

In addition, a transfer member 162L, a transfer member 162K, a transfer member 162Y, a transfer member 162M, and a transfer member 162C are disposed to face the invisible image recording unit 15, the visible image recording unit 14K, the visible image recording unit 14Y, the visible image recording unit 14M, and the visible image recording unit 14, respectively, with the intermediate transfer member 16 provided therebetween. The toner images formed on the image supports 152L, 152K, 152Y, 152M, and 152C are transferred onto the intermediate transfer member 16 by the transfer member 162L, the transfer member 162K, the transfer member 162Y, the transfer member 162M, and the transfer member 162C, respectively. The residual toner adhering to the intermediate transfer member 16 is removed by a remover 189 provided downstream of a secondary transfer position.

In the paper transport path 18, a paper feed member 180 that takes out the recording medium 10 from the paper feed device 17 and plural support members 181, 182, 183, and 184 are disposed. In addition, a support member 185 is disposed at the second transfer portion on the paper transport path 18 so as to be pressed into contact with the support member 168.

The recording medium 10 supplied from the paper feed device 17 is transported on the paper transport path 18. The invisible dots 30A, the visible dots 30B, and the visible dots 30C transferred onto the intermediate transfer member 16 are secondarily transferred onto the recording medium 10 by the contact pressure and electrostatic force of the support member 185. As a result, the infrared image 30 and the related image 32 are transferred onto the recording medium 10, and the recording medium 10 is transported to the fixing device 19 by transport belts 186 and 187.

The fixing device 19 melts and fixes the toners constituting the invisible dots 30A, the visible dots 30B, and the visible dots 30C on the recording medium 10 to the recording medium 10 by applying heat and pressure thereto. Consequently, the infrared image 30 and the related image 32 formed of the invisible dots 30A, the visible dots 30B, and the visible dots 30C are formed on the recording medium 10. The recording medium 10 on which the infrared image 30 and the related image 32 are formed is discharged to the outside along arrow B.

Next, the functional configuration of the image processing device 20 is described.

The image processing device 20 forms the first printing data, the second printing data, and the third printing data by image processing such as synthesis processing, which will be described below, for image data input from the outside such as a personal computer or the like through a network line or radio line, and outputs the printing data to the image formation control device 21. In the exemplary embodiment, description is made assuming that the image data input from the outside includes related image data that indicates the related image 32 (refer to FIG. 1) to be formed on the recording medium 10 and infrared image data that indicates the infrared image 30.

The related image data includes information indicating that the related image is recorded with a visible recording material, and information indicating the size and position (position on the recording medium 10) of each of the dots constituting the related image 32 and indicating that each of the dots is a invisible dot having infrared absorptivity.

The infrared image data includes information indicating that the image is recorded with a recording material having infrared absorptivity, and information indicating the color, size, and position (position on the recording medium 10) of each of the dots constituting the infrared image 30 and indicating that each of the dots is a visible dot having infrared absorptivity.

In the exemplary embodiment, it is assumed that the information indicating the position of each of the dots is set in the related image data and the infrared image data so that the infrared image 30 and the related image 32 are formed in the same specified area 12 on the recording medium 10.

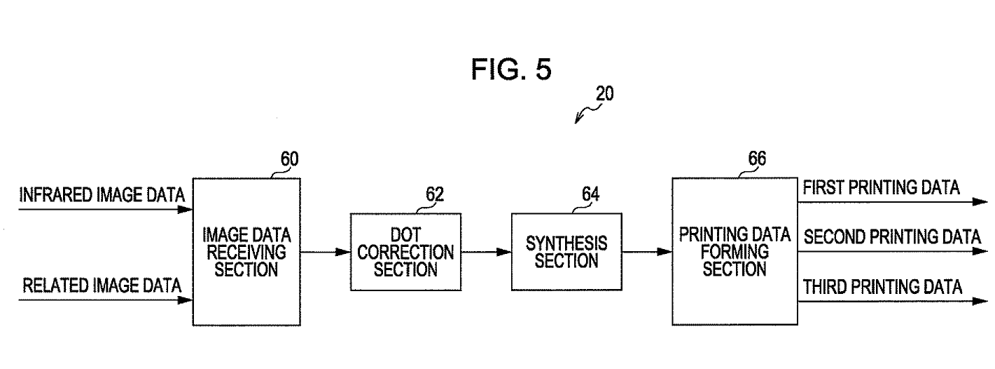

As shown in FIG. 5, the image processing device 20 includes an image data receiving section 60, a dot correction section 62, a synthesis section 64, and a printing data output section 66.

Each of the components included in the image processing device 20 may be realized by a software using CPU (Central Processing Unit), memory, and program, or may be realized by a hardware using ASIC (Application Specified Integrated Circuit). The image processing device 20 may be included in, for example, a personal computer or the like as well as the image forming apparatus 11.

In the image processing device 20, the image data receiving section 60 receives the infrared image data and the related image data, that are included in the image data, from the outside, and outputs the data to the dot correction section 62. The dot correction section 62 detects the infrared image data by reading the information that is contained in the infrared image data received from the image data receiving section 60 and that indicates the image is recorded with a recording material having infrared absorptivity. Also, the dot correction section 62 detects the related image data by reading the information that is contained in the related image data and that indicates the image is recorded with a visible recording material.

In addition, the dot correction section 62 corrects information indicating the size of each dot so that the size of each of the dots constituting the infrared image 30 indicated by the infrared image data is the same as the size of each of the dots constituting the related image 32 indicated by the related image data. Then, the corrected related image data and infrared image data are output to the synthesis section 64.

The synthesis section 64 synthesizes the related image data and the infrared image data by exclusive-OR operation for information of each of the dots to be formed at the same position in the infrared image data corrected by the dot correction section 62 and the related image data corrected by the dot correction section 62. The synthetic data and the related image data and infrared image data before synthesis are output to the printing data output section 66. In detail, information about dots corresponding to a position of overlap between each of the dots constituting the infrared image in the infrared image data and each the dots constituting the related image in the related image data is regarded as information that indicates visible dots having infrared absorptivity (the visible dots 30B). In addition, information about dots other than the dots corresponding to the position of overlap among the dots constituting the infrared image is regarded as information that indicates invisible dots having infrared absorptivity (the invisible dots 30A). Further, information about dots other than the dots corresponding to the position of overlap among the dots constituting the related image is regarded as information that indicates visible dots not having infrared absorptivity (the invisible dots 30C). In this way, the synthesis processing is performed.

The printing data output section 66 forms the first printing data for recording the invisible dots 30A by extracting dot information that indicates invisible dots having infrared absorptivity from the dots constituting the composite image of the synthetic data output from the synthesis section 64. The first printing data is output to the image formation control device 21.

Also, the printing data output section 66 forms the second printing data for recording the visible dots 30B by extracting dot information that indicates visible dots having infrared absorptivity from the dots constituting the composite image of the synthetic data output from the synthesis section 64. The second printing data is output to the image formation control device 21.

Further, the printing data output section 66 forms the third printing data for recording the visible dots 30C by extracting dot information that indicates visible dots not having infrared absorptivity from the dots constituting the composite image of the synthetic data output from the synthesis section 64. The third printing data is output to the image formation control device 21.

The image formation control device 21 that receives the first printing data, the second printing data, and the third printing data controls the invisible image recording unit 15 based on the first printing data, controls the visible image recording unit 14K based on the second printing data, and controls the visible image recording unit 14 based on the third printing data. As a result, in the invisible image recording unit 15, the invisible dots 30A corresponding to the first printing data are transferred to the intermediate transfer member 16. In the visible image recording unit 14K, the visible dots 30B corresponding to the second printing data are transferred to the intermediate transfer member 16. Further, in the visible image recording unit 14, the visible dots 30C corresponding to the third printing data are transferred to the intermediate transfer member 16. Consequently, the related image 32 and the infrared image 30 are formed in the specified area 12 on the recording medium 10. The infrared image 30 formed in the specified area 12 is formed of plural dots having infrared absorptivity, and part of the plural dots are visible dots that constitute the related image 32 formed in the specified area 12.

Therefore, even when the related image 32 and the infrared image 30 are formed in the same area, a decrease in infrared reading accuracy of the infrared image 30 due to the related image 32 is considered to be suppressed.

In the exemplary embodiment, a mode using an electrophotographic image forming apparatus as an apparatus for forming the infrared image 30 and the related image 32 on the recording medium 10 is described by way of example. However, an ink jet printer may be used, and of course, an apparatus for typography, offset printing, flexographic printing, gravure printing, serigraph, or the like may be used.

### TEST EXAMPLES

Dyes with infrared absorptivity used for recording the invisible dots 30A and the visible dots 30B are described in detail below.

### Test Example 1

### Preparation of Perimidine-Based Squarylium Dye: Two-Step Synthesis

A mixed solution containing 4.843 g (98%, 30.0 mmol) of 1,8-diaminonaphthalene, 3.886 g (98%, 30.2 mmol) of 3,5-dimethylcyclohexanone, 10 mg (0.053 mmol) of p-toluenesulfonic acid monohydrate, and 45 ml of toluene was heated under stirring in a nitrogen gas atmosphere and refluxed for 5 hours. The water produced during the reaction was removed by azeotropic distillation. After the completion of the reaction, toluene was distilled off to produce a dark brown solid. The resultant solid was then extracted with acetone, purified by recrystallization from a mixed solvent of acetone and ethanol, and then dried to produce 7.48 g (yield 93.6%) of a brown solid. The results of ¹H-NMR spectral (CDCl₃) analysis of the brown solid are shown below.

¹H-NMR spectrum (CDCl₃): δ=7.25, 7.23, 7.22, 7.20, 7.17, 7.15 (m, 4H, Hₐᵣₒₘ); 6.54 (d×d, J₁=23.05 Hz, J₂=7.19 Hz, 2H, Hₐᵣₒₘ); 4.62 (br s, 2H, 2×NH); 2.11 (d, J=12.68 Hz, 2H, CH₂); 1.75, 1.71, 1.70, 1.69, 1.67, 1.66 (m, 3H, 2×CH, CH₂); 1.03 (t, J=12.68 Hz, 2H, CH₂); 0.89 (d, J=6.34 Hz, 6H, 2×CH₃); 0.63 (d, J=11.71 Hz, 1H, CH₂)

A mixed solution containing 4.69 g (17.6 mmol) of the brown solid, 913 mg (8.0 mmol) of 3,4-dihydroxycyclobut-3-ene-1,2-dione, 40 ml of n-butanol, and 60 ml of toluene was heated under stirring in a nitrogen gas atmosphere and reacted under reflux for 3 hours. The water produced during the reaction was removed by azeotropic distillation. After the completion of reaction, most of the solvent was distilled off in a nitrogen gas atmosphere, and 120 ml of hexane was added to the residual reaction product under stirring. The resultant blackish brown precipitates were filtered off with suction, washed with hexane, and then dried to produce a blackish blue solid. The resultant solid was washed in order with ethanol, acetone, a 60% aqueous ethanol solution, ethanol, and acetone to produce 4.30 g (yield 88%) of a target compound (blackish blue solid).

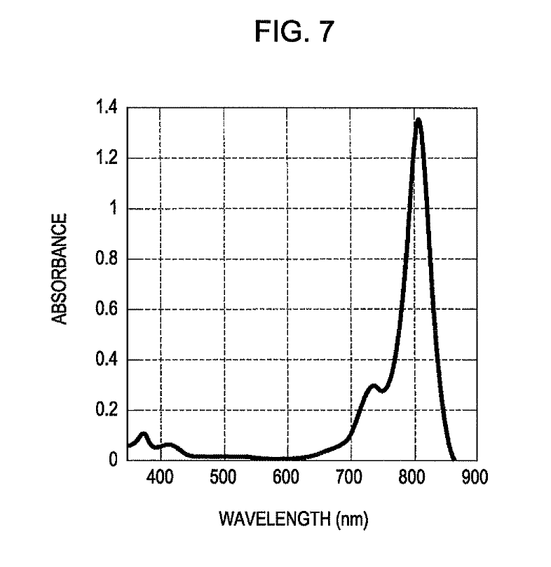

The resulting dye compound was identified by spectroscopy such as an infrared absorption spectrum (KBr disk method), ¹H-NMR (DMSO-d₆), FD-MS, elemental analysis, visible near-infrared absorption spectrum, etc. The identification data is shown below. A visible near-infrared absorption spectrum is shown in FIG. 7. As a result of identification, the resultant compound was confirmed as a perimidine-based squarylium dye represented by the structural formula (I).

Infrared absorption spectrum (KBr disk method):

νₘₐₓ=3487, 3429, 3336 (NH), 3053 (═C—H), 2947 (CH₃), 2914, 2902 (CH₂), 2864 (CH₃), 2360, 1618, 1599, 1558, 1541 (C═C ring), 1450, 1421, 1363 (CH₃, CH₂), 1315, 1223, 1201 (C—N), 1163, 1119 (C—O—), 941, 924, 822, 783, 715 cm⁻¹

¹H-NMR spectrum (DMSO-d₆): δ=10.52 (m, 2H, NH); 7.80, 7.78 (d, 2H, Hₐᵣₒₘ); 7.35, 7.33 (m, 2H, Hₐᵣₒₘ); 7.25 (m, 2H, NH); 6.82, 6.80, 6.78 (m, 4H, Hₐᵣₒₘ); 6.74, 6.72, 6.52, 6.50 (m, 2H, Hₐᵣₒₘ); 2.17 (m, 5H, CH₂); 1.91 (m, 3H, CH₂); 1.71 (m, 2H, CH, CH₂); 1.15, 1.12 (m, 4H, CH₂); 0.92, 0.91 (m, 12H, 4×CH₃); 0.66 (m, 2H, CH₂)

Mass spectrum (FD): m/z=610 (M⁺, 100%), 611 (M⁺+1, 47.5%)

Elemental Analysis:

C, 78.6% (measured value), 78.66% (calculated value)

H, 6.96% (measured value), 6.93% (calculated value)

N, 9.02% (measured value), 9.17% (calculated value)

O, 5.42% (measured value), 5.24% (calculated value)

Visible near-infrared absorption spectrum (FIG. 7):

λₘₐₓ=809 nm (in a tetrahydrofuran solution)

εₘₐₓ=1.68×10⁵ M⁻¹ cm⁻¹ (in a tetrahydrofuran solution)

### (Pigment-Forming Treatment)

Next, 51 g of the resulting perimidine-based squarylium dye, 25 g of a 12% by mass aqueous solution of sodium dodecylbenzenesulfonate, and 425 g of water were charged in a beads mill (manufactured by Ashizawa Finetech Ltd., Minicer), and the mill was operated for 3 hours using 485 g of 0.1 mm-diameter beads at a peripheral speed of 12 m/sec. As a result of measurement of a particle size distribution of the recovered perimidine-based squarylium dye (hereinafter referred to as “particles (A)”), the median diameter was 65.9 nm.

### Test Example 2

First, 50 mg of the perimidine-based squarylium dye particles (hereinafter referred to as a “raw material”) before the pigment-forming treatment in Test Example 1, 1 mL of tetrahydrofuran (THF), and 10 g of zirconia beads having a diameter of 1 mm were placed in a ball mill container, followed by milling for 1 hour. Then, water was added to the ball mill container, and perimidine-based squarylium dye particles (hereinafter referred to as “particles (B)”) were recovered by filtration trough a 50 nm filter.

### (Powder X-Ray Diffraction Analysis)

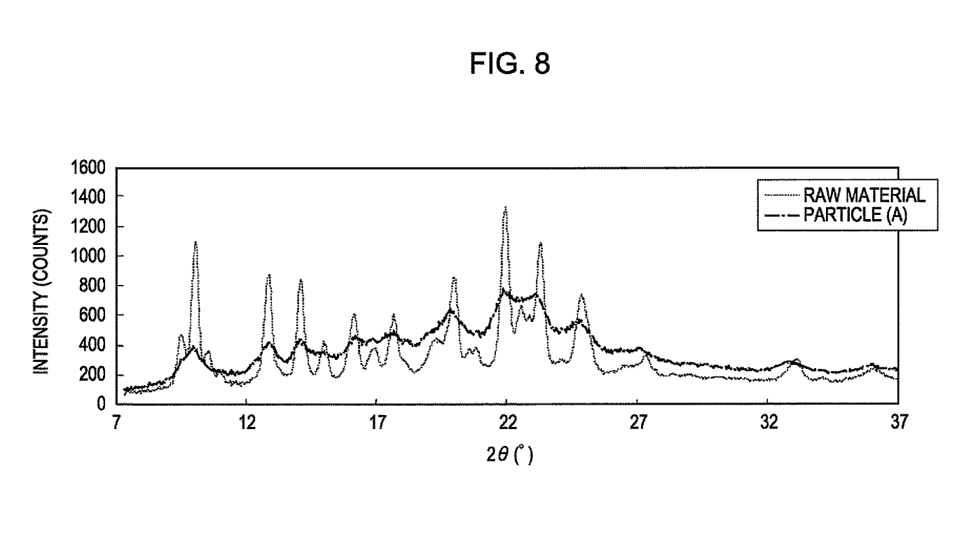

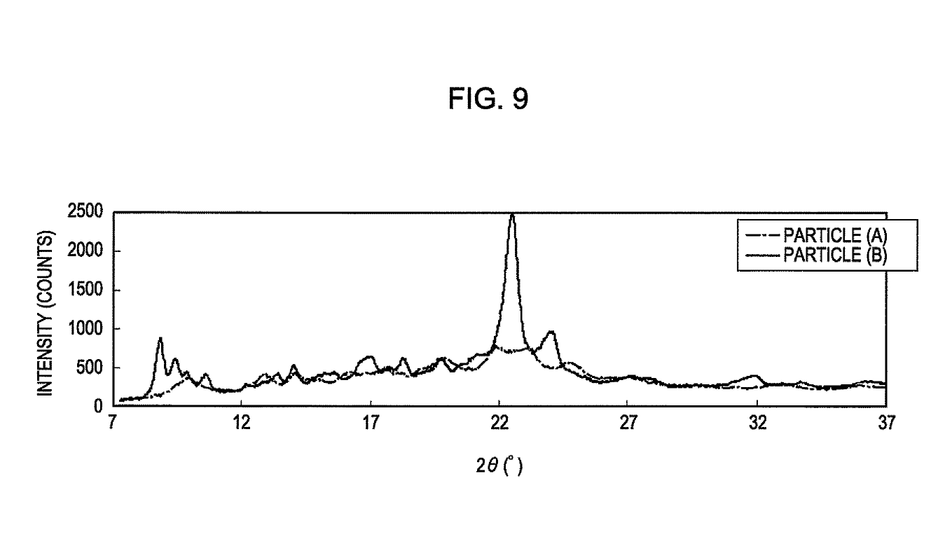

Powder X-ray diffraction was measured for the perimidine-based squarylium dye particles (hereinafter referred to as a “raw material”) before the pigment-forming treatment in Test Example 1, the particles (A) in Test Example 1, and the particles (B) in Test Example 2 by X-ray irradiation of μ=1.5405 Å using a Cu target and an X-ray analyzer (“D8 DISCOVER” manufactured by Bruker AXS Co., Ltd.). The obtained powder X-ray diffraction spectra are shown in FIGS. 8 and 9.

FIG. 8 reveals that the particles (A) show diffraction peaks at Bragg angles (2θ±0.2°) of 22.1°, 23.2°, 19.9°, 24.9°, and 17.7° in the descending order of intensities and has the same crystal system as the raw material. However, FIG. 9 reveals that the particles (B) show diffraction peaks at Bragg angles (2θ±0.2°) of 22.6°, 24.2°, 8.9°, 17.1°, and 18.4° in the descending order of intensities and has a crystal system different from that of the raw material and the particles (A).

### Test Example 3

A usual vanadyl phthalocyanine dye (hereinafter referred to as “VONPc”) was prepared.

### Test Example 4

A dye compound represented by formula (VII) below was formed into particles by the following method.

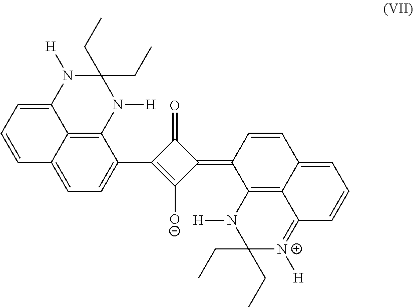

First, 40 mg of a dye compound represented by the formula (VII) was dissolved in 30 mL of THF, and the resultant solution was injected into 2000 mL of ice-cold distilled water using a micro-syringe to produce precipitates. Several minutes after, the mixture was returned to room temperature, and the filtrates were filtered off with a 50 nm filter, washed with distilled water, and then vacuum-dried to recover reprecipitated dye compound (hereinafter referred to as “particles (C)”). The median diameter d50 of the particles (C) was about 90 nm. A powder X-ray diffraction spectrum of the particles (C) was measured by X-ray irradiation of λ=1.5405 Å using a Cu target in the same manner as in Test Example 2. As a result, substantially no diffraction peak derived from a crystal was observed, and thus the particles (C) obtained by the reprecipitation method were amorphous.

### Test Example 5

First, 40 mg of the particles (C) obtained by the reprecipitation method in Test Example 4, 5 mL of hexane, and 10 g of agate beads having a diameter of 1 mm were placed in a ball mill container, followed by milling for 8 hours. Then, water was added to the ball mill container, and particles (hereinafter referred to as “particles (D)”) of the dye compound were recovered by filtration with a 50 nm filter. The median diameter d50 of the particles (D) was about 90 nm. A powder X-ray diffraction spectrum of the particles (D) was measured by X-ray irradiation of λ=1.5405 Å using a Cu target in the same manner as in Test Example 2. As a result, the particles (D) showed diffraction peaks at Bragg angles (2θ±0.2°) of at least 11.9°, 13.1°, 15.4°, 19.0°, 20.4°, 23.0°, 23.9°, 24.6°, and 26.4°, and thus had high crystallinity.

### —Evaluation—

### —Preparation of Slurry—

First, 9.2 mg of each of the particles (A) prepared in Test Example 1, the particles (B) prepared in Test Example 2, VONPc prepared in Test Example 3, the particles (C) prepared in Test Example 4, and the particles (D) prepared in Test Example 5 were ultrasonically dispersed together with 46 μl of a 12% by mass aqueous solution of sodium dodecylbenzenesulfonate and 5.52 ml of distilled water to prepare a slurry (ultrasonic wave output: 4 to 5 W, using a ¼ inch horn, irradiation time: 30 minutes). The sample concentration in the slurry was 0.165% by mass.

### —Evaluation of Readability—

A mixed solution of 40.4 μl of slurry (sample concentration: 0.165% by mass) of the particles (A) prepared in Test Example 1, 15 μl of a 40% by mass latex (poly(styrene-n-butyl acrylate) solution, and 5 g of distilled water was dispersed using Ultra Turrax to prepare mixed slurry. Then, a PAC aggregating agent was added to the resultant mixed slurry to prepare a pseudo toner dispersion solution. The resultant dispersion solution was filtered with a 220 nm filter, air-dried, and subjected to thermocompression bonding at 120° C. to form a latex patch for evaluation with a gram number per square meter (TMA) of 4 g/m² and a pigment mass per unit area (PMA) of 0.04 g/m² (corresponding to a pigment content 1% by mass in toner).

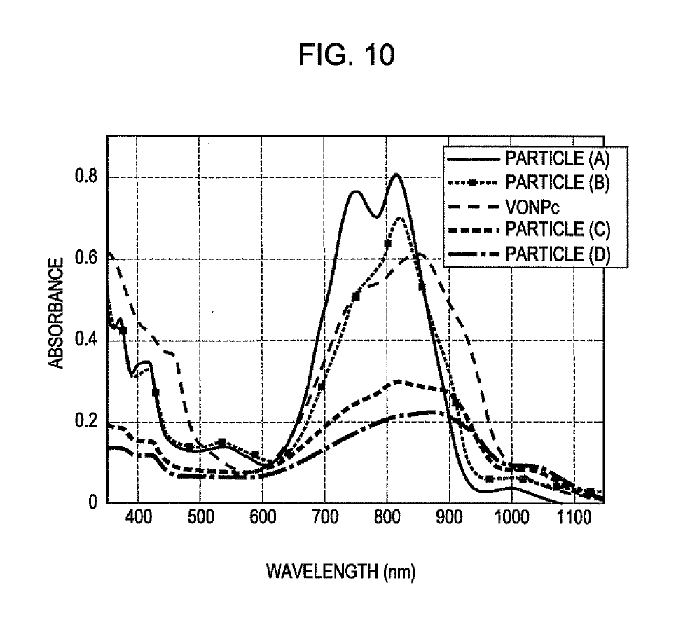

A visible near-infrared absorption spectrum of the resultant latex patch was measured with spectrophotometer U-4100 manufactured by Hitachi, Ltd. The result is shown in FIG. 10. In addition, R (initial reflectance at 850 nm) the expression (III) was determined. The result of R is shown in Table 1.

A mixed slurry was prepared by the same method as for the particles (A) except that each of the particles (B) prepared in Test Example 2, VONPc prepared in Test Example 3, the particles (C) prepared in Test Example 4, and the particles (D) prepared in Test Example 5 were used in place of the particles (A) in the slurry. In addition, latex patches for evaluation were formed for measuring visible near-infrared absorption spectra, and R in the expression (III) was determined. The evaluation results are shown in FIG. 10 and Table 1.

### —Evaluation of Invisibility—

For the latex patch for evaluation which was formed using each of the particles (A) in Test Example 1, the particles (B) in Test Example 2, VONPc in Test Example 3, the particles (C) in Test Example 4, and the particles (D) in Test Example 5, ΔE in the expression (II) was determined. The evaluation results are shown in Table 1.

In addition, ΔE was determined by measurement using a reflection spectrodensitometer (X-Rite 939 manufactured by X-Rite Inc.).

The evaluation criteria for invisibility were as follows:

A: 0≦ΔE≦6

B: 6<ΔE≦16

C: ΔE>16

### —Evaluation of Light Resistance—

The latex patch for evaluation which was formed using each of the particles (A) prepared in Test Example 1, the particles (B) prepared in Test Example 2, VONPc prepared in Test Example 3, the particles (C) prepared in Test Example 4, and the particles (D) prepared in Test Example 5 was irradiated with light for 3 hours (light source: xenon lamp, irradiance: 540 W/m²=100 klux, without a UV cut filter).

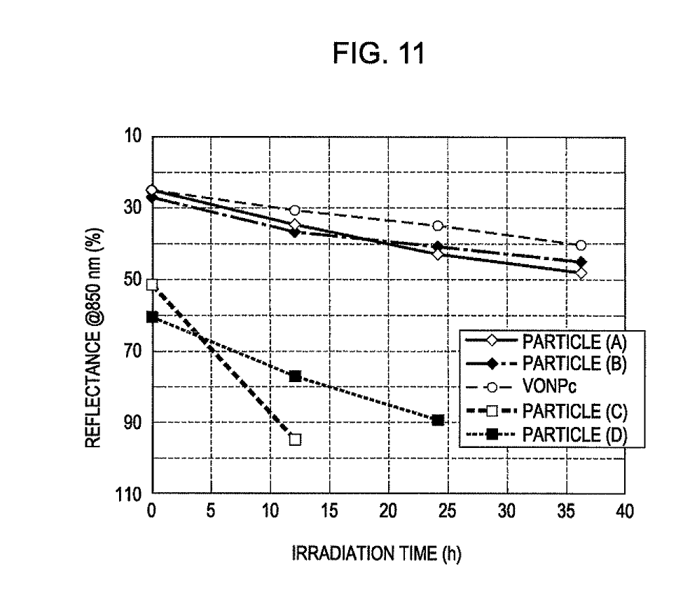

During the irradiation, reflectance at 850 nm was measured with spectrophotometer U-4100 manufactured by Hitachi, Ltd. with every 12 hours to evaluate light resistance. FIG. 11 shows a relation between the reflectance and irradiation time of the latex patches for evaluation.

The evaluation criteria for readability and light resistance were as follows. The evaluation results are shown in Table 1.

Evaluation criteria for readability:

A (particularly good readability): R≦25

B (good readability): 25<R≦40

C (readable): R>40

Evaluation criteria for light resistance:

A (particularly good light resistance): reflectance at 850 nm (%) after 24-hour irradiation ≦44

B (good light resistance): 44<reflectance at 850 nm (%) after 24-hour irradiation ≦66

C (light-resistant): reflectance at 850 nm (%) after 24-hour irradiation >66

TABLE 1

| | | | | | | Light |
|---|---|---|---|---|---|---|
| | Dye | R (%) | ΔE | Readability | Invisibility | resistance |
| Test | (A) | 21.34 | 5.6 | A | A | A |
| Example 1 | | | | | | |
| Test | (B) | 28.29 | 6.1 | B | A | A |
| Example 2 | | | | | | |
| Test | VONPc | 24.76 | 32.4 | B | C | C |
| Example 3 | | | | | | |
| Test | (C) | 51.73 | 9.02 | C | B | C |
| Example 4 | | | | | | |
| Test | (D) | 60.72 | 8.9 | C | B | C |
| Example 5 | | | | | | |

As described above, with the particles (A) and (B) prepared in Test Examples 1 and 2, respectively, the readability and light resistance are greatly improved while invisibility is maintained in comparison with the particles prepared in Test Examples 3 to 5.

Therefore, when the invisible dots 30A having infrared absorptivity are formed using a recording material containing either of the particles (A) and (B) prepared in Test Examples 1 and 2, the infrared light readability is further improved while invisibility is maintained in comparison with the case in which the invisible dots 30A are formed using a dye prepared in any one of Test Examples 3 to 5.

In addition, when the visible dots 30B having infrared absorptivity are formed using a recording material containing either of the particles (A) and (B) prepared in Test Examples 1 and 2 and a visible colorant, the infrared light readability is further improved in comparison with the case in which the visible dots 30B are formed using a dye prepared in any one of Test Examples 3 to 5 in place of either of the particles (A) and (B) prepared in Test Examples 1 and 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium comprising:
a first image that is read with infrared light and that is formed of a plurality of dots having infrared absorptivity, part of the plurality of dots being invisible first dots, the remaining dots being visible second dots; and
a visible second image that is formed of the second dots or the second dots and visible third dots not having infrared absorptivity.

2. The recording medium according to claim 1, wherein the second image indicates related information about the first image.

3. The recording medium according to claim 1, wherein the size of the first dots is the same size of the second dots.

4. The recording medium according to claim 1, wherein the first dots are formed from a recording material containing a perimidine-based squarylium dye represented by the following structural formula (I):

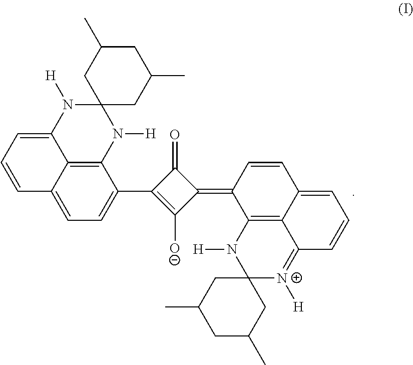

5. The recording medium according to claim 4, wherein the second dots are formed from a recording material containing a perimidine-based squarylium dye represented by the structural formula (I).

6. The recording medium according to claim 4, wherein the perimidine-based squarylium dye represented by the structural formula (I) shows diffraction peaks at Bragg angles (2θ±0.2°) of at least about 17.7°, 19.9°, 22.1°, 23.2°, and 24.9° in a powder X-ray diffraction spectrum measured by X-ray irradiation at a wavelength of 1.5405 Å using a Cu target.

7. An image forming apparatus comprising:
a first recording device that records invisible first dots having infrared absorptivity;
a second recording device that records visible second dots having infrared absorptivity; and
a control device that controls the first recording device and the second recording device so as to form, on a recording medium, a first image that is read with infrared light and that is formed of the first dots and the second dots and a second image that is formed of the second dots.

8. The image forming apparatus according to claim 7, further comprising:
a third recording device that records visible third dots not having infrared absorptivity,
wherein the control device controls the second recording device and the third recording device so as to form a visible image formed of the second dots and the third dots as the second image on the recording medium.
